(19) United States
(12) Patent Application Publication
(10) Pub. No.: US 2016/0042897 A1
(43) Pub. Date: Feb. 11, 2016

(54) MECHANISMS HAVING A MAGNETIC LATCH AND TACTILE FEEDBACK

(71) Applicant: Apple Inc., Cupertino, CA (US)

(72) Inventor: Amy Qian, Cupertino, CA (US)

(21) Appl. No.: 14/456,074

(22) Filed: Aug. 11, 2014

(51) Int. Cl. H01H 36/00

(52) U.S. Cl. CPC H01H 36/004; H01H 36/0033

(57) ABSTRACT

A mechanism using one or more pairs of magnets to generate a force that provides tactile feedback and/or a latching force for the mechanism. The one or more pairs of magnets may be used to generate a specific tactile response that may mimic the response of a traditional purely mechanical system. The a pair of magnets may also be used to generate a latching force that retains or holds a movable element when activated.

### TECHNICAL FIELD

This disclosure relates generally to mechanisms having one or more magnets, and more specifically to mechanisms that use one or more magnets to create a latch or produce an appropriate tactile response.

### BACKGROUND

Traditionally, a latch, lock or push button mechanism includes one or more components that are configured to mechanically engage each other to perform the respective function. In addition, these mechanisms may also provide a tactile response to the user. In some cases, the tactile response of a mechanism is an inherent property of the physical engagement of one or more mechanical components of the mechanism. For example, a mechanical latch may produce a tactile resistance as a cam or locking mechanism is moved over and through a center locking position. Similarly, a button may produce a familiar tactile resistance as a spring is compressed and eventually, an electrical contact is made.

A tactile response may provide as feedback to the user that the function is complete or that the mechanism is operating properly. The tactile response of a mechanism may also contribute to the user's perception of quality or refinement. However, as devices and mechanisms become miniaturized and simplified, the mechanical interaction between the components may produce resistance that is too small or unfamiliar to provide meaningful tactile feedback to the user. Additionally, some mechanical systems include multiple mechanical components that may wear or be susceptible to failure over repeated use. The reliability of a mechanical system may be even more difficult to achieve as some traditional mechanisms and components are miniaturized to fit the compact form factor of some modern hand-held devices.

As described herein, one or more magnets can be used to provide a latch function and/or tactile feedback for a mechanism. Therefore, there is a need for a magnet-based mechanism that provides both the function and desirable tactile feedback on a reduced scale without sacrificing reliability or having the limitations of some traditional mechanisms.

### SUMMARY

The embodiments described herein are directed to various mechanisms using one or more pairs of magnets to generate a force that provides tactile feedback and/or a latching force for the mechanism. In some embodiments, one or more pairs of magnets may be used to generate a specific tactile response that may mimic the response of a traditional purely mechanical system. In some embodiments, a pair of magnets may be used to generate a latching force that retains or holds a movable element when activated.

One example embodiment is directed to a sliding mechanism having a magnetic latch. In this example, the mechanism includes a base and a sliding element slidably engaged with respect to the base. The sliding element is configured to move between an open and closed position. The mechanism also includes a first magnet having a first polarity orientation. The first magnet is fixed with respect to the base, and is located proximate to the sliding element. In this example, the sliding element also includes a second magnet having a second polarity orientation that is opposite to the first polarity orientation. The second magnet is fixed with respect to the sliding element, and is configured to be nearest to the first magnet when the sliding element is at an intermediate position that is between the open and closed position.

In some embodiments, the first and second magnets are configured to generate a resistance force that resists a closing motion when moving the sliding element from the open position to the closed position. In some cases, the resistance force is at a maximum at a slide location immediately before the intermediate position as the sliding element is being closed. The first and second magnets may also be configured to generate a latching force that resists an opening motion when moving the sliding element from the closed position to the open position. In some cases, the latching force is at a maximum at a slide location immediately before the intermediate position as the sliding element is being opened. In some cases, the sliding element is a tray and the base is a housing of a portable electronic device.

Another example embodiment is directed to a button mechanism having a magnetic latch. The mechanism includes a housing and a button slidably engaged with respect to the base and configured to move between an up and down position. The mechanism also includes a first magnet having a first polarity orientation and that is fixed with respect to the housing. In this example, the first magnet is located proximate to the button. In this example, the mechanism also includes a second magnet having a second polarity orientation that is opposite to the first polarity orientation and is fixed with respect to the button. In the present example, the second magnet is configured to be nearest to the first magnet when the button is at an intermediate position that is between the up and down position.

In some example embodiments the button is a key of a keyboard device. In other example embodiments, the button is the control button of a portable electronic device.

In some embodiments, the mechanism also includes a spring configured to provide a return force to restore the button to the up position. In some embodiments, the second magnet is an electrically actuated electromagnet.

In some examples, the first and second magnets are configured to generate a resistance force that resists an actuation motion when moving the button from the up position to the down position. In some examples, the resistance force is at a maximum at a button location immediately before the intermediate position as the button is being actuated.

Another example embodiment is directed to button mechanism having a magnetic catch. The mechanism includes a housing and a button slidably engaged with respect to the housing and configured to move between an up and down position. In this example, the mechanism includes a first magnet having a first polarity orientation. The first magnet is fixed with respect to the housing and is located proximate to the button. In this example, the mechanism also includes a second magnet having a second polarity orientation that is the same as the first polarity orientation. The second magnet is fixed with respect to the button and magnet is configured to be nearest to the first magnet when the button is at an offset position that is between the up and down position. In some examples, the mechanism also includes a spring that is configured to provide a return force to restore the button to the up position.

Another example embodiment is directed to a magnetic latch mechanism including an actuating member having a first and second magnet oriented along a first axis. The first and second magnet have opposite polarity orientations. The latch mechanism also includes a slide that is oriented along a second axis that is transverse to the fist axis. The slide has a third magnet at one end. In the present example, the first and third magnets are configured to produce an unlocking force when the actuating member is in a first position, and the second and third magnets are configured to produce a locking force when the actuating member is in a second position. In some embodiments, the latch mechanism also includes a movable element having a locking feature. In this case, the locking force causes the slide to mechanically engage the locking feature when the actuating member is in the second position. In some cases, the first and third magnets each have a polarity orientation that is substantially opposite to each other, and the second and third magnets each have a polarity orientation that is substantially aligned with each other. In one alternative embodiment, the actuating member is configured to rotate about an axis, wherein when the actuating member is rotated the first and second magnet may be placed proximate to the third magnet of the slide.

Another example embodiment is directed to a key mechanism of a keyboard device having a magnetic catch. In this example, the key mechanism includes a base and a key slidably engaged with respect to the base that is configured to move between an up and down position. The mechanism also includes a first magnet having a first polarity orientation and fixed with respect to the base and a second magnet that is fixed with respect to the key and having a second polarity orientation that is the same as the first polarity orientation. In the present example, the second magnet is configured to be nearest to the first magnet when the button is at the down position. In some embodiments, the key mechanism also includes a spring configured to provide a return force to restore the key to the up position.

### BRIEF DESCRIPTION OF THE DRAWINGS

FIG. 1 depicts an example device having an example slide mechanism and an example button mechanism.

FIGS. 2A-B depict an example slide mechanism having a magnetic latch.

FIG. 3 depicts an example tactile response for a slide mechanism having a magnetic latch.

FIGS. 4A-B depict an example button mechanism having a magnetic latch.

FIG. 5A depicts an example tactile response for a button mechanism having a magnetic latch.

FIG. 5B depicts an example tactile response for a button mechanism having a dome switch.

FIGS. 6A-B depict an example button mechanism having a magnetic catch.

FIG. 7 depicts an example tactile response for a button mechanism having a magnetic catch.

FIGS. 8A-B depict an example keyboard key mechanism having a magnetic latch configuration.

FIG. 9 depicts an example tactile response for a keyboard key mechanism having a magnetic latch and spring configuration.

FIGS. 10A-B depict an example keyboard key mechanism having a magnetic catch configuration.

FIG. 11A depicts an example tactile response for a keyboard key having a magnetic catch configuration.

FIG. 11B depicts an example tactile response for a keyboard key having a traditional configuration.

FIG. 12 depicts a simplified schematic of an example magnetic latch mechanism.

FIGS. 13A-B depict an example magnetic latch mechanism.

FIGS. 14A-B depict example magnetic mechanisms having a rotating member.

### DETAILED DESCRIPTION

The description that follows includes example systems and processes that embody various elements of the present disclosure. However, it should be understood that the described disclosure may be practiced in a variety of forms in addition to those described herein.

The present disclosure includes various mechanisms using one or more pairs of magnets to generate a force that provides tactile feedback and/or a latching force for the mechanism. As described in more detail below, one or more pairs of magnets may be used to generate a specific tactile response that may mimic the response of a traditional purely mechanical system. A pair of magnets may also be used to generate a latching force that retains or holds a movable element when activated. One advantage of some of the magnetic mechanisms described herein is that the configuration and strength of the magnets may be tuned to provide the desired force feedback to the user. Additionally, the mechanisms may include fewer moving parts, as compared to a traditional mechanical system. Furthermore, some of the mechanisms may be readily scalable and capable of being integrated into some compact handheld devices

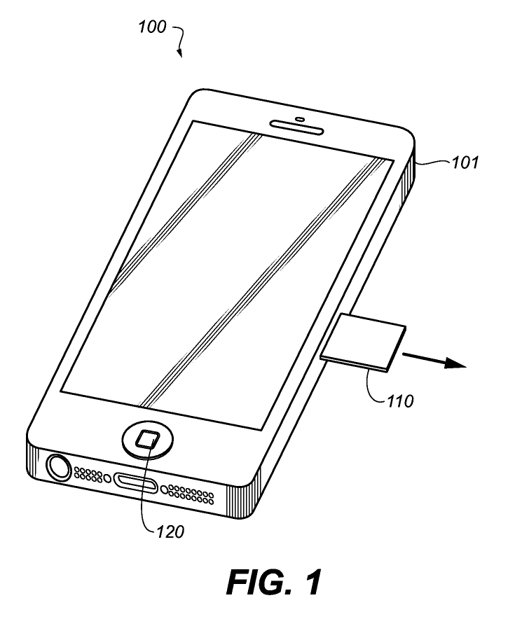

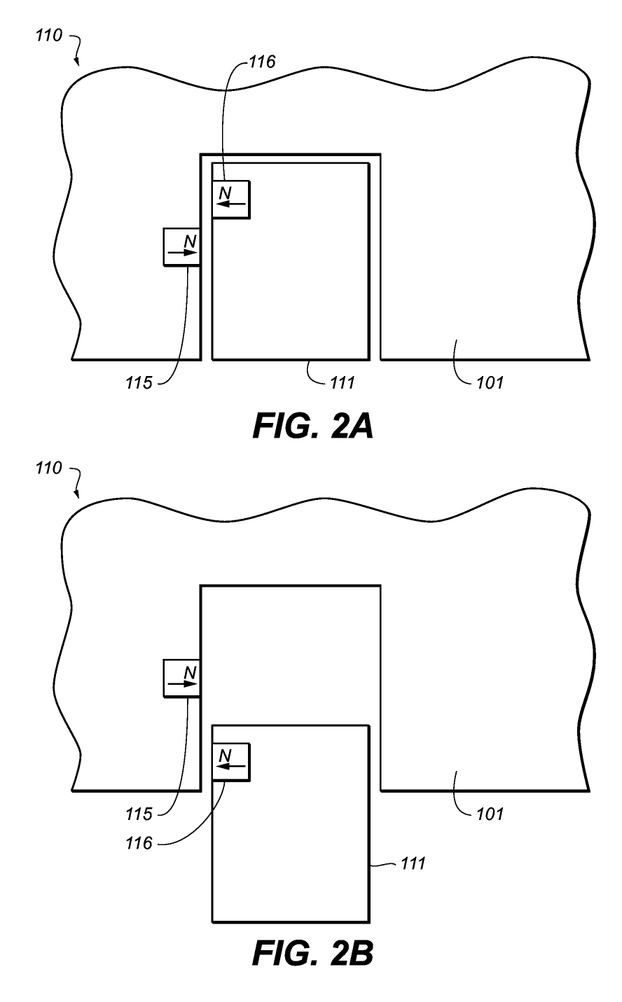

FIG. 1 depicts an example portable device having one or more magnetic mechanisms. In particular, FIG. 1 depicts a portable electronic device 100 having both a slide mechanism 110 and a button mechanism 120 integrated into the housing 101. In this example, the slide mechanism 120 includes a movable tray for inserting a Subscriber Identity Module (SIM) card into the portable electronic device 101. The button mechanism 120 is a user-operated button that can be used to provide user input to the electronic device 101. A more detailed description of both of these mechanisms is provided below with respect to FIGS. 2A-B, 4, and 6A-B.

The electronic device 101 depicted in FIG. 1 is a mobile device having a display screen, speaker, microphone, and electronics for performing wireless voice and data communications. This is provided as merely one type of example device. The mechanisms described herein, including the button mechanism 120 and the slide mechanism 110, may be integrated into a variety of other types of devices, including, for example, a notebook computer, a desktop computer, a portable media player, a wearable device, a keyboard, touch pad, or similar portable electronic device. Additionally, the mechanisms described herein may be integrated into other types of devices, including, for example, a fixture device, an electrical appliance, automobile component, or a consumer product.

FIGS. 2A-B depict an example slide mechanism having a magnetic latch. In particular, FIGS. 2A-B depict an example slide mechanism 110 having a sliding element or tray 111 slidably engaged with a base or housing 101. In this example, the tray 111 is a card tray that may be used to insert an electronic card or memory device into a housing 101. This is provided as merely one example and a similar configuration may be used for other type of sliding devices.

As shown in FIGS. 2A-B, the slide 111 is configured to move between an open position (FIG. 2B) and a closed position (FIG. 2A). As shown in FIG. 2A, a pair of magnets 115, 116 may be configured to function as a latching mechanism and also provide tactile feedback to the user as the slide 111 is moved. In particular, if the pair of magnets 115, 116 have an opposite polarity, and are arranged to slide past each other as the slide 111 is opened or closed, a sheer force between the pair of magnets 115, 116 may provide both a latching force and a familiar tactile resistance to the user.

In the present example, the first magnet 115 may have a first polarity orientation that is oriented substantially perpendicular to the actuation direction of the slide 111. As shown in FIGS. 2A-B, the first magnet 115 is fixed with respect to the housing 101. In some cases the first magnet 115 is attached directly to the housing 101 and, in other cases, the first magnet 115 is attached to another component that is fixed with respect to the housing 101. As also shown in FIGS. 2A-B, the first magnet 115 is located proximate to the slide 111. In this example, the first magnet 115 is separated from the slide 111 by a clearance gap that may facilitate motion between the components and may also include a bearing or guide element (not shown).

In the present example, the second magnet 116 has a second polarity orientation that is substantially opposite to the first polarity orientation of the first magnet 115. Thus, the first and second magnets 115, 116 tend to produce a repulsive force as the magnets are moved toward each other. As also shown in FIGS. 2A-B, the second magnet 116 is fixed with respect to the slide 111. In some cases, the second magnet 116 is attached directly to the slide 111 and, in other cases, the second magnet 116 is attached to another component that is fixed with respect to the slide 111.

As shown in FIGS. 2A-B, the pair of magnets 115, 116 are configured to pass each other as the slide is actuated between the open and closed (or closed and open) positions. In particular, the second magnet 116 is configured to be nearest to the first magnet 115 when the slide 111 is at an intermediate position that is between the open and closed position. When the slide 111 is in the intermediate position, the slide 111 may be in an unstable balanced state. Generally, the slide 111 and may tend to move toward the open or closed position if located slightly off center of the intermediate position. Thus, this magnet configuration may result in a normally-open or normally-closed slide condition, depending on the bias of the slide toward one end or the other. In some cases, this configuration is also described as a latch or latching mechanism.

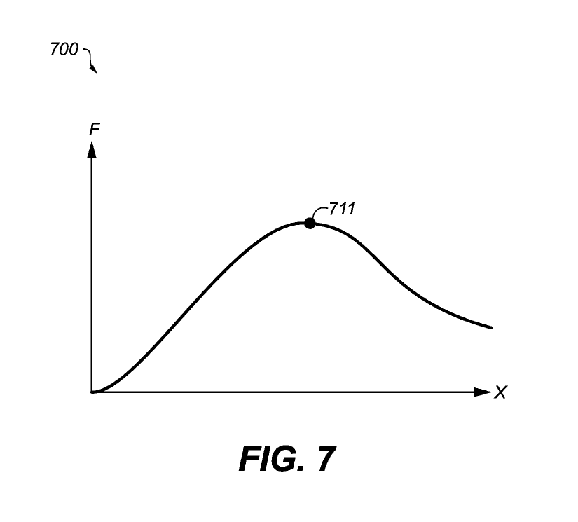

In an alternative configuration, the polarity of one of the magnets may be reversed to create an inherently stable mechanism also referred to herein as a catch mechanism. In this alternative configuration, the slide may tend to stay in an intermediate position due to the attractive forces of the magnets. In some cases, the magnets may be arranged so that the slide location, where the magnets are closest to each other, is associated with a closed or open position. An example of this configuration is described below with respect to FIGS. 6A-B Thus, the arrangement of the magnets may configured to produce either a normally-closed or a normally-open condition using a magnetic catch.

Returning to the magnetic latch configuration of FIGS. 2A-B, a magnetic latch may provide several advantages. First, the repulsion force between the pair of magnets 115, 116 may provide a latching force that helps to hold the tray 111 in the closed position, as depicted in FIG. 2A. Second, the repulsive force generated by the pair of magnets 115, 116 may also provide retaining force that helps to hold the tray 111 in the open position, as shown in FIG. 2B. Note that the tray 111 and/or housing 101 may also include one or more features that functions as a stop, preventing the tray 111 from being fully removed from the housing 101 during normal operation.

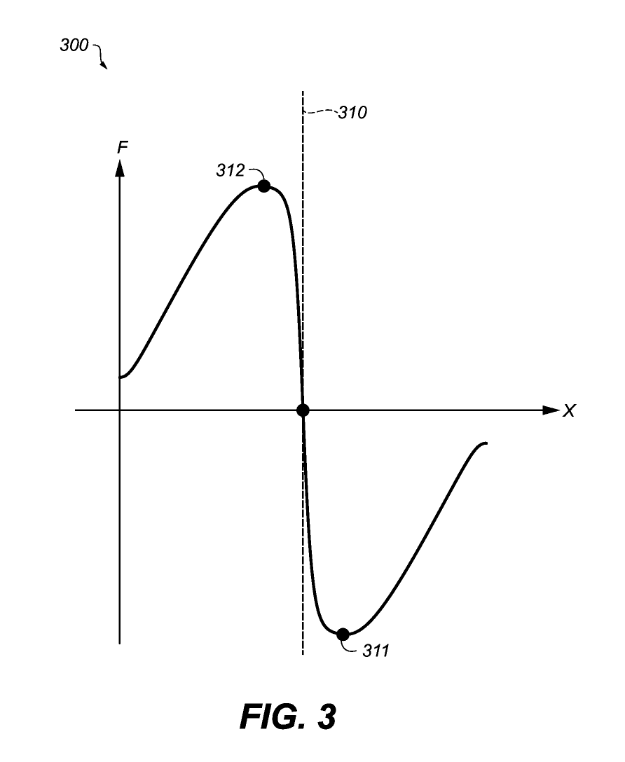

The pair of magnets 115, 116 may also provide a tactile response that provides tactile feedback to the user. FIG. 3 depicts an example tactile response for a slide mechanism having a magnetic latch, as depicted in FIGS. 2A-B. In particular, FIG. 3 depicts a tactile response curve 300 expressed as force F as a function of actuation distance x. In the example graph of FIG. 3, the position x is zero when the slide is open and the position x increases as the slide is closed. The force F represents the force exerted on the user's finger or an external object. In the example depicted in FIG. 3, a positive force represents a pushing force or resistance against the user's finger (or external object) and a negative force represents a pulling force, as perceived by the user's finger (or external object).

As shown by the curve 300 of FIG. 3, the pair of magnets are configured to generate a resistance force that resists a closing motion when moving the slide from the open position (FIG. 2B) to the closed position (FIG. 2A). This is indicated in curve 300 by an increasing force F as the distance x is increased from the open position (x=0). As shown in FIG. 3, the resistance force is at a maximum 312 at a slide location immediately before the intermediate position 310 as the slide is being closed. This provides a (positive) resistive tactile response to the user that may resemble a spring-loaded drawer mechanism.

As the user continues to push the slide past the intermediate position 310, the positive resistance force changes to a negative pulling force, which may help draw the slide into the housing. In some case, the negative pulling force creates a snap or click as the slide is drawn into the closed position and seats within the housing. The snap or click may be perceived by the user and indicate to the user that the slide has been fully closed and that the action is complete. As shown in FIG. 3, the magnets maintain a (small) negative force when the slide is fully closed due to the repulsion force between the magnets. This negative force helps to maintain the slide in the closed position, similar to the function of a traditional mechanical latch.

In some cases, the initial resistance followed by a positive snap, as depicted in force curve 300, also corresponds to an example desirable tactile response. The peak resistance 312, as well as the shape of the force curve 300, may be adapted by changing parameters such as, the strength of the magnets, the location of the magnets relative to the movement of the slide, and slide mechanism itself. By optimizing one or more of those parameters, the slide mechanism may be configured to produce a custom force curve profile that satisfies a user tactile feedback criteria.

Similarly, as indicated by the force curve 300 of FIG. 3, the pair of magnets are also configured to generate a latching force that resists an opening motion when moving the slide from the closed position (FIG. 2A) to the open position (FIG. 2B). This is indicated in curve 300 by an increasing force F as the distance x is decreased from the closed position (maximum x). As shown in FIG. 3, the latching force is non-zero (negative) when the slide is fully closed and increases to a maximum (negative) force 311 at a slide location immediately before the intermediate position 310 as the slide is being opened. This provides a (negative) pulling force that helps to maintain the slide in the closed position. As discussed above, the peak latching force 311, as well as the shape of the force curve 300, may be adapted by optimizing the strength of the magnets and the location of the magnets with respect to the relative movement of the slide.

The examples provided above use two permanent magnets to achieve a latching slide with a particular tactile force response. However, in other examples, additional magnets may be used. For example, an additional magnet pair may be used on another portion of the slide to provide a force feedback profile that is congruent with the other magnet pair. In some cases, a second set of magnets are included to provide a force feedback profile that is offset from the other magnet pair to produce a combined or composite force feedback profile having a plateau or multiple local maxima regions.

Additionally, one or more of the permanent magnets could also be an electromagnet having a force that can be selectively controlled by a controller or electronic circuitry. In particular, the polarity of one of the magnets of the pair can be momentarily reversed to provide an attraction force between the two magnets. This may be done, for example, to help eject the slide from the housing by causing an alignment of the two magnets. In some cases, the polarity of the magnets may be momentarily reversed to initiate an ejection of the slide, and then reversed (back) again to push slide to the fully open position. The operation of the electromagnet may be based on timing and/or a position sensor used to detect the location of the slide.

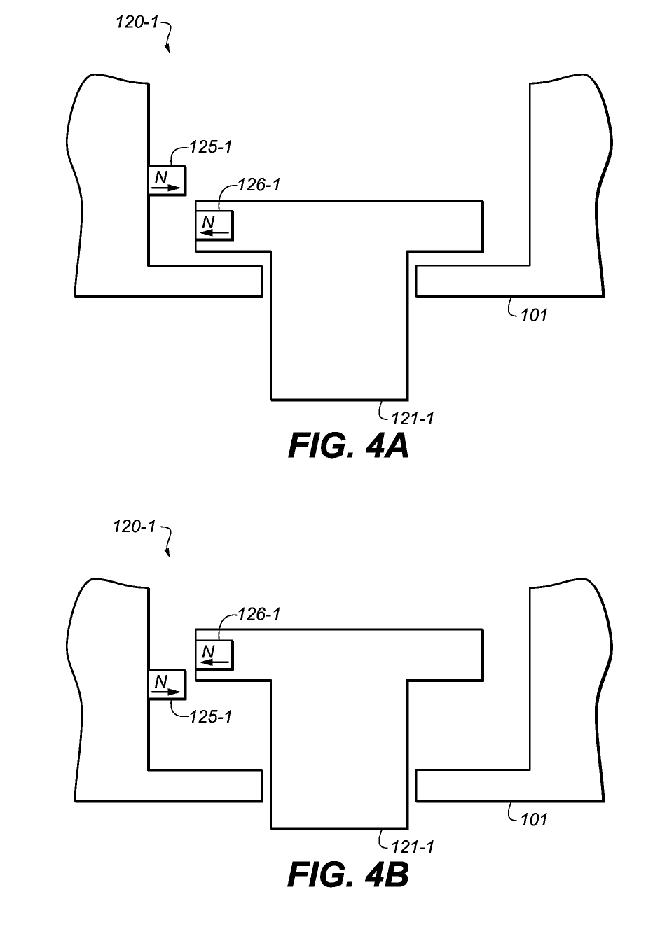

The techniques discussed above with respect to the slide mechanism may also be applied to a button mechanism. FIGS. 4A-B depict an example button mechanism having a magnetic latch. In particular, FIGS. 4A-B depict an example button mechanism 120-1 having a button 121-1 slidably engaged with a base or housing 101. As shown in FIGS. 4A-B, the button 121-1 is configured to move between an up or undepressed position (FIG. 4A) and a down or depressed position (FIG. 4B). As shown in FIG. 4B, a pair of magnets 125-1, 126-1 may be configured to function as a latching mechanism and also provide tactile feedback to the user as the button 121-1 is moved. Similar to as described above with respect to the slide mechanism, the pair of magnets 125-1, 126-1 may have an opposite polarity, and may be arranged to slide past each other as the button is actuated. The repulsive force generated by the magnets 125-1, 126-1 may provide both a latching force and a familiar tactile resistance to the user.

The configuration of the first 125-1 and second 126-1 magnets of the button mechanism 120-1 is similar to as described above with respect to the slide mechanism 110. That is, the first magnet 125-1 may have a first polarity orientation that is oriented substantially perpendicular to the actuation direction of the button 121-1, is fixed with respect to the housing 101, and is located proximate to the button 121-1. Similarly, the second magnet 126-1 has a second polarity orientation that is substantially opposite to the first polarity orientation of the first magnet 125-1 and is fixed with respect to the button 121-1. As shown in FIGS. 4A-B, the pair of magnets 125-1, 126-1 are configured to pass each other as the button is actuated between the up and down positions. In particular, the second magnet 216 is configured to be nearest to the first magnet 125-1 when the button 121-1 is at an intermediate position that is between the up and down position. When the button 121-1 is in the intermediate position, the button 121-1 may be in an unstable balanced state. In some cases, the button 121-1 and may tend to move toward either the up or down position if the button 121-1 is located slightly off center of the intermediate position. As discussed previously, this magnet configuration may result in a normally-up or normally-down button condition, depending on the bias of the button toward one end or the other, and may be described as a latch or latching mechanism. As described in more detail with respect to FIGS. 6A-B, the polarity of one of the magnets may be reversed to create an inherently stable mechanism also referred to herein as a catch mechanism.

The magnet configuration depicted in FIGS. 4A-B may provide several advantages. First, the repulsive force generated by the pair of magnets 125-1, 126-1 may provide a tactile resistance when the button 121-1. Second, the repulsion force between the pair of magnets 125-1, 126-1 may also provide a latching force holds the button 121-1 down once actuated.

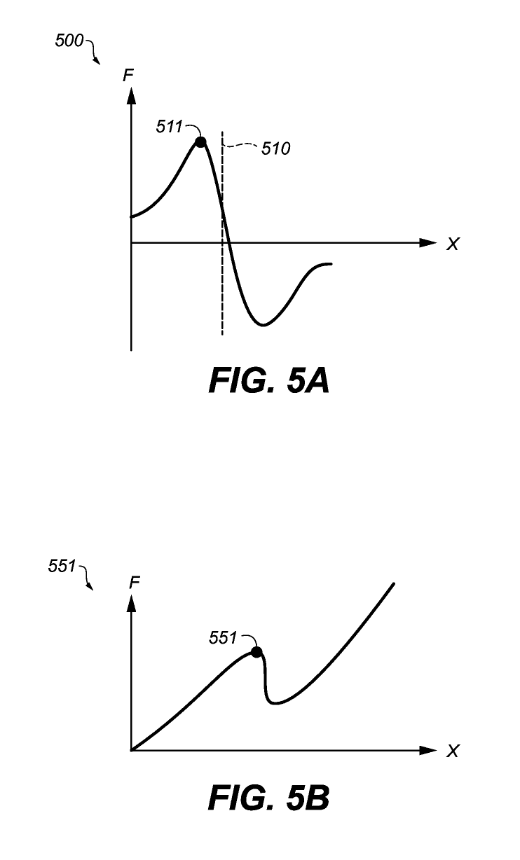

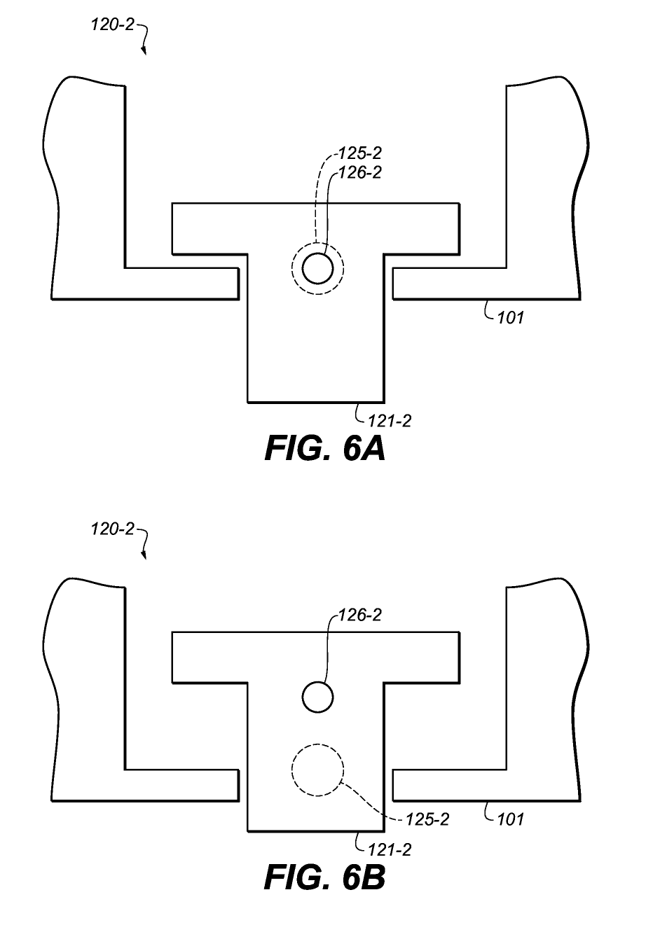

FIG. 5A depicts an example tactile response for a button mechanism having a magnetic latch, as depicted in FIGS. 4A-B. In particular, FIG. 5A depicts a tactile response curve 500 expressed as force F as a function of actuation distance x. In the example graph of FIG. 5, the position x is zero when the button is up or un-depressed and the position x increases as the button is pressed or in a depressed state. As in the previous example, a positive value for the force F represents a resistance as viewed from the perspective of the user or an external object.

As shown by the curve 500 of FIG. 5A, the pair of magnets are configured to generate a resistance force that resists an actuation or depression motion when moving the button from the up position (FIG. 4A) to the down position (FIG. 4B). In particular, the pair of magnets produce an increasing resistance as the button is pressed toward the intermediate position 510. The resistance reaches a local maximum resistance at a point 511 just before the intermediate position 510. As shown in FIG. 5A, after button passes the intermediate position 510, the pair of magnets help pull the button into the down or depressed position. In some cases, this results in a positive tactile initial resistance followed by a positive snap or click as the button is drawn all the way down. This may provide positive feedback to the user and indicate that the actuation is complete and contact has been made.

In some cases, the button also includes a spring that may provide a return force to restore the button to an undepressed state or up position after the user has removed his or her finger. In some cases, the spring force is strong enough to overcome the latching force provided by the pair of magnets. While the spring may reduce the net latching force, the user may still perceive a tactile snap or click as the button is actuated through its full stroke. Additionally, in some cases, one of the magnets may be an electromagnet that can be selectively actuated. In one example, the electromagnet is engaged or operable as the button is being depressed. The electromagnet may then be selectively disengaged or shut off after the button is depressed allowing the button to return to the up or undepressed state when the user lifts his or her finger.

Compare the force curve 500 of FIG. 5A representing a button having a pair of magnets with the force curve 550 of FIG. 5B representing a button having a traditional dome switch. As shown in FIG. 5B, the button having a dome switch also provides an initial resistance that increases to a local maximum 551. As the dome switch is depressed past the maximum point, the dome may yield and/or invert resulting in a positive click or snap at the bottom of the button stroke. Thus, as shown in the example force curves 500 and 550, a button having a pair of magnets can be configured to mimic the tactile response of a traditional button having a dome switch.

One added benefit of the magnet-operated button, as shown in FIGS. 4A-B is that the tactile response may be tuned or optimized by selecting an appropriate strength of magnet and/or magnet location within the button mechanism. Additionally, if one or both of the magnets are an electromagnet, the tactile force of the button can be variable or customized using a controller or other electronic circuit. Furthermore, as discussed above with respect to the slide mechanism, more than one pair of magnets may be used to produce multiple local maxima or a plateauing tactile feedback depending on the relative location of the additional pair of magnets.

Alternatively, magnet pairs may also be used to provide a catch for a button assembly. FIGS. 6A-B depict an example button mechanism 120-2 having a magnetic catch. As shown in FIGS. 6A-B, the button mechanism 120-2 may include a button 121-2 that is slidably engaged with respect to the housing 101 or a base. As in the previous example, the button 121-2 is configured to move between an offset position (FIG. 6A) and a down or depressed position (FIG. 6B).

The button mechanism 120-2 also includes a pair of magnets 125-2 and 126-6 that are configured to act as a catch. In particular, the first magnet 125-2 is fixed with respect to the housing 101 and has a first polarity orientation. As shown in FIG. 6A, the second magnet 216-2 may be located proximate to the first magnet 125-2 when the button is in an offset position that is just below a full up or maximum extension position. In this example, the second magnet 126-2 has a second polarity orientation that is the same as the first polarity orientation. Thus, the pair of magnets 125-2 and 126-2 produce an attractive force and may be used to help maintain the button 121-2 in the offset position shown in FIG. 6A. Note that due to the gap between the button 212-2 and a retaining feature of the housing, the button 121-2 may be extended further outward from the offset position shown in FIG. 6A.

The magnet configuration depicted in FIGS. 6A-B, represents an inherently stable mechanism when the button is located in the offset position depicted in FIG. 6A (where the two magnets 125-2, 126-2 are closest to each other). As previously suggested, the polarity of one of the magnets 125-2, 126-2 may be reversed to change the mechanism into a latch mechanism that may be inherently instable at a position where the magnets 125-2, 126-2 are closest to each other.

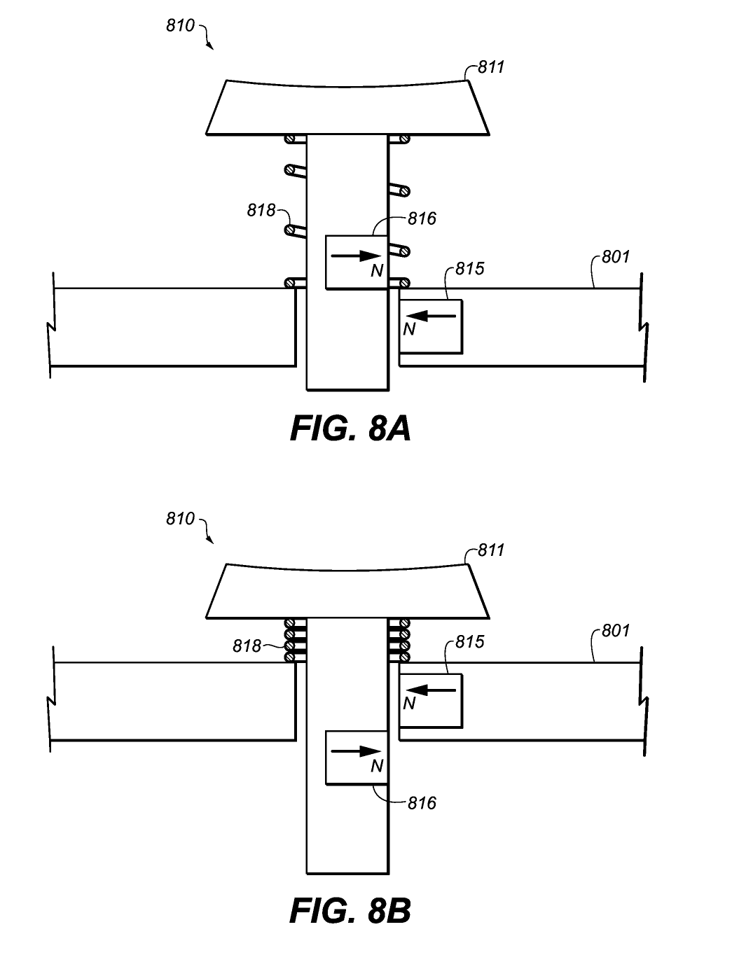

In the configuration depicted in FIGS. 6A-B, the button mechanism 120-2 may also provide a desirable tactile response. In particular, as shown in FIG. 7, the button mechanism having a pair of magnets as shown in FIGS. 6A-B, may result in a tactile response represented by the force curve 700. As shown in FIG. 7, the button mechanism may have a maximum force at position 711. When the user apples a force to actuate the button, once the force may increase to the maximum force (position 711) after which the force may gradually decrease. In some cases, the button produces a slight release as the magnets move past position 711, providing a tactile indication that the button has been actuated. In some cases, the button assembly also includes a spring that helps to return the button to the offset position when the user-provided force is removed.

Another potential benefit of the button configuration 120-2, as shown in FIGS. 6A-B is that the offset or undepressed position of the button may be more precisely controlled. In some cases, the first magnet 125-2 is fixed with respect to the housing 101 using a high-accuracy manufacturing technique. For example, the first magnet 125-2 may be attached to a cavity that is machined or molded into the housing 101. This may improve the accuracy of the placement of the button 121-2 with respect to the housing 101 as compared to other techniques, using for example, the height of a dome switch or hard stop to locate the button 121-2. Additionally, the first or second magnets 125-2, 126-2 may be adjustable to provide an adjustable offset position for the button 121-2.

FIG. 7 depicts an example tactile response for a button mechanism having a magnetic catch, as depicted in FIGS. 6A-B. In particular, FIG. 7 depicts a tactile response curve 700 expressed as force F as a function of actuation distance x. In the example graph of FIG. 7, the position x is zero when the button is up or un-depressed and the position x increases as the button is pressed or in a depressed state.

As shown by the curve 700 of FIG. 7, the pair of magnets are configured to generate a maximum resistance force at position 711. As shown in FIG. 7, the resistance generated by the pair of magnets initially increases and then decreases resistance as the button is pressed toward the down or fully actuated position. In some case, the reduced resistance force results in a slight release as the button moves more easily into the down or actuated position after position 711. The tactile release may be perceived by the user and indicate to the user that the slide has been fully closed and that the action is complete.

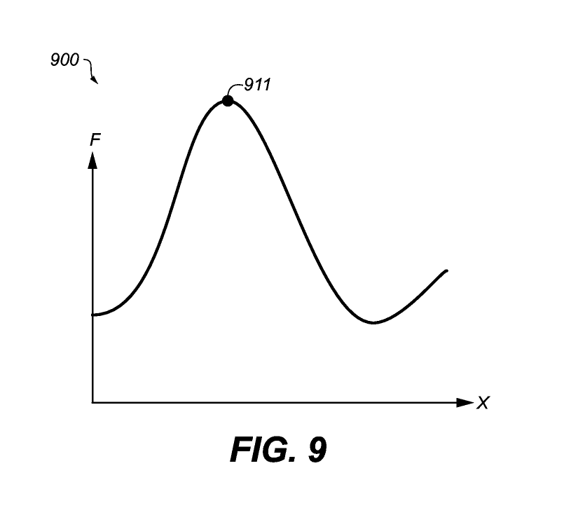

In some embodiments, magnet pairs can also be used to provide a desirable tactile response or actuation for the keys of a keyboard. As explained in more detail with respect to FIGS. 8A-B and 9A-B, below, a magnet pair can be configured similar to either a magnetic latch or a magnetic catch to provide a specific tactile response.

FIGS. 8A-B depict an example keyboard key mechanism having a magnetic latch configuration. In particular, FIGS. 8A-B depict an example key mechanism 810 having a key 811 slidably engaged with a base or housing 801. The engagement between the key and housing is depicted as a key shaft configured to slide with respect to a mating hole in the housing 801. This is provided as a simplified example and other slidable engagement configurations are also possible. For example, a linkage or diaphragm could be used in addition to or alternative to slidably engage the key with respect to the housing 801. The key mechanism 810 also includes a spring 818, depicted in this example as a coil compression spring. However, in other embodiments, an elastic diaphragm, membrane, rubber dome, or other component could also be used as a spring. The key mechanism 810 also includes a pair of contacts for making an electrical connection and for sensing the actuation of the key 811. The contacts are omitted from FIGS. 8A-B for clarity, but may be integrated into the key mechanism 810 according to traditional keyboard techniques.

As shown in FIGS. 8A-B, the key 811 is configured to move between an up or undepressed position (FIG. 8A) and a down or depressed position (FIG. 8B). As shown in FIG. 8B, a pair of magnets 815, 816 may be configured to function as a latching mechanism and also provide tactile feedback to the user as the key 821 is moved. Similar to as described above with respect to the slide and button mechanisms (FIGS. 2A-B and 4A-B), the pair of magnets 815, 816 may have an opposite polarity, and may be arranged to slide past each other as the key is actuated. The repulsive force generated by the magnets 815, 816 in combination with a spring force provided by a spring 818 may provide a satisfying tactile resistance to the user.

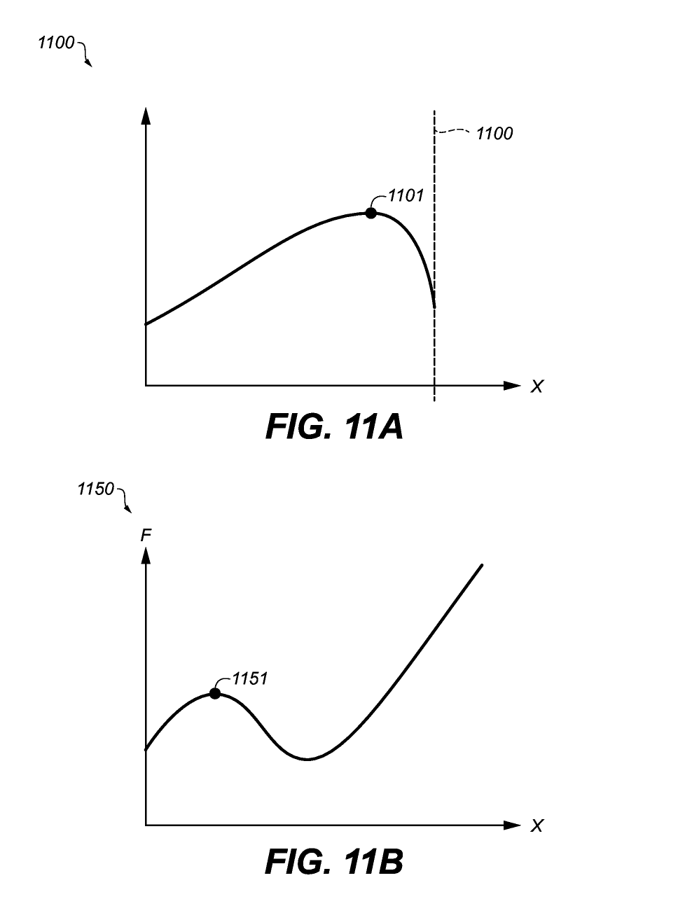

The configuration of the first 815 and second 815 magnets of the key mechanism 810 may be similar to as described above with respect to the slide mechanism 110 of FIGS. 2A-B. That is, the first magnet 815 may have a first polarity orientation that is oriented substantially perpendicular to the actuation direction of the key 811, is fixed with respect to the housing 801, and is located proximate to the key 811. Similarly, the second magnet 816 has a second polarity orientation that is substantially opposite to the first polarity orientation of the first magnet 815 and is fixed with respect to the key 811. As shown in FIGS. 8A-B, the second magnet 816 is configured to be nearest to the first magnet 815 when the key 811 is at an intermediate position that is between the up and down position. As previously discussed, an intermediate position may be an unstable balanced position. As also previously discussed, the polarity of one of the magnets 815, 816 may be reversed or flipped to provide an inherently stable mechanism, also referred to as a magnetic catch. Another example mechanism having a magnetic catch is provided below with respect to FIGS. 10A-B.

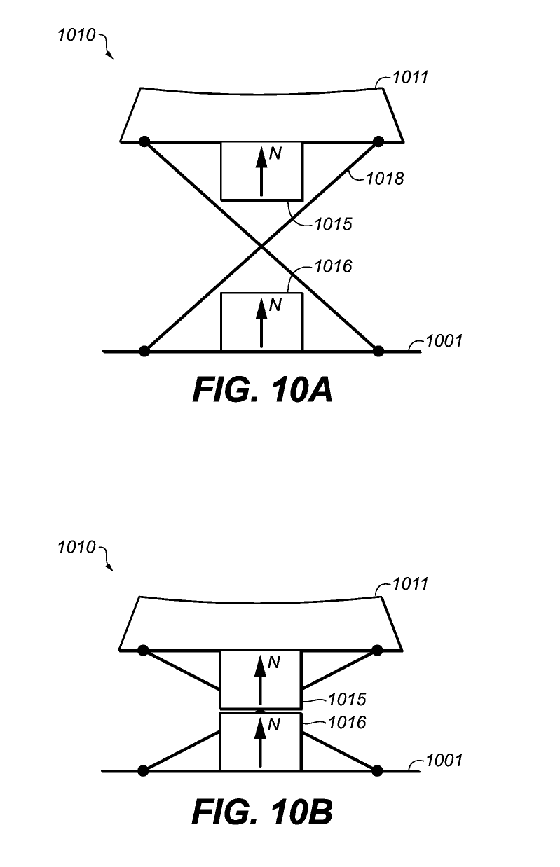

The magnet configuration depicted in FIGS. 8A-B may provide a tactile or force response that is desirable for keyboard operation. FIG. 9 depicts an example tactile response 900 for a key mechanism having a pair of magnets and a spring, as described above with respect to FIGS. 8A-B. As shown in FIG. 9, when a user presses on a key, the resistance increases to a maximum resistance 911 just before the magnets are aligned. Once the user presses past the alignment location, the resistance drops significantly through the remainder of the key stroke. The increasing force provided by the spring (e.g., item 818 in FIGS. 8A-B) may prevent the force from becoming negative and also prevent the key from being stuck in the down position. In an alternative embodiment, one or both of the magnets are an electromagnet that can be selectively operated to either provide a specific tactile feedback and/or be turned off to allow the key to return to an up position.

FIGS. 10A-B depict an example keyboard key having a magnetic catch configuration. In particular, FIGS. 10A-B depict an example key mechanism 1010 having a key 1011 slidably engaged with a base or housing 1001. In this example, the sliding engagement is provided with a sliding linkage 1018 having a pair of fixed upper pivots attached to the key 1011 and a pair of lower sliding pivots near the housing 1001. This is provided as one example and other slidable engagement configurations are possible, as described above with respect to FIGS. 8A-B. The key mechanism 1010 also includes a pair of contacts for making an electrical connection and for sensing the actuation of the key 1011. The contacts are omitted from FIGS. 10A-B for clarity, but may be integrated into the key mechanism 1010 according to traditional keyboard techniques.

As shown in FIGS. 10A-B, the key mechanism 1010 also include a pair of magnets 1015, 1016. The first magnet 1015 is fixed with respect to the key 1011 and has a first polarity orientation, as indicated. The second magnet 1016 is fixed with respect to the housing 1001 and has a second polarity orientation that is substantially the same as the first polarity orientation of the first magnet 1015. Because the magnet polarities are in the same direction, the magnets 1015, 1016 tend to attract each other. The key mechanism 1010 may also include a spring to provide upward resistance during the key stroke. An example spring is depicted above with respect to the key mechanism 810 of FIGS. 8A-B.

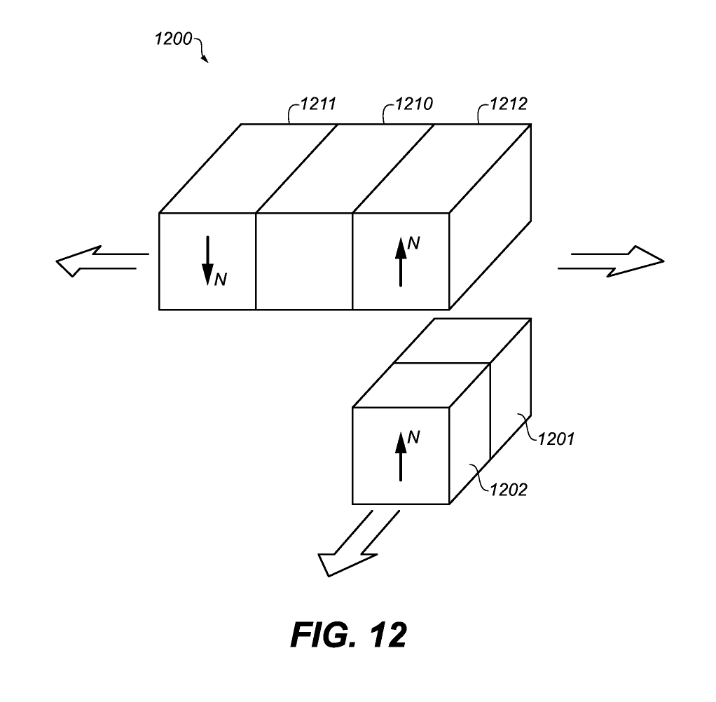

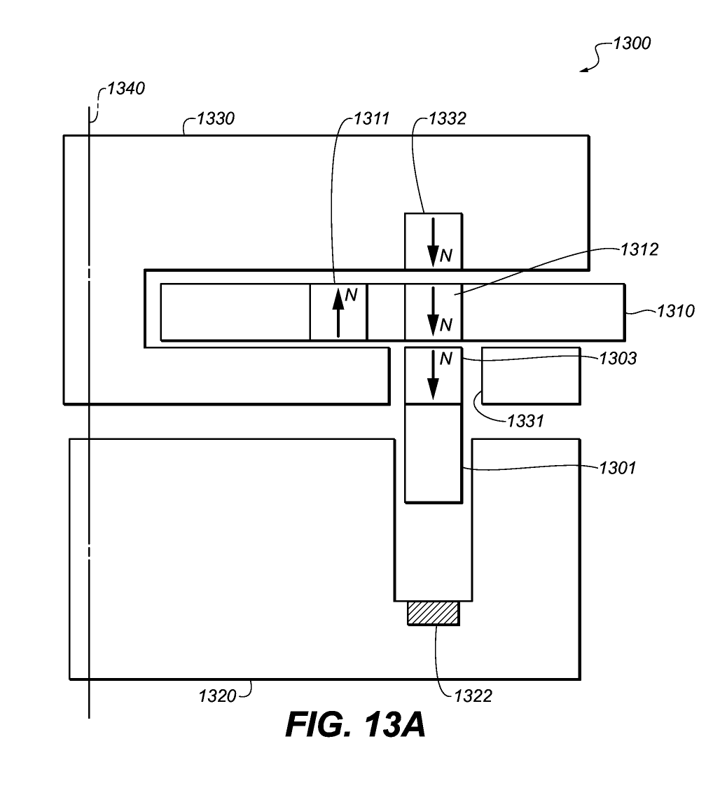

In some cases, one or both of the magnets 1015, 1016 are electromagnets that can be selectively controlled using electronics or an electronic controller. In some cases, the electromagnet may be operated to provide a specific tactile response. FIG. 11A depicts an example tactile response 1100 for a keyboard key having a magnetic catch configuration. As in the previous examples, x=0 at when the key is up and increases as the key is pressed downward. As shown in FIG. 11A, the resistance may increase to a maximum 1101 as the user presses the key. The increasing resistance may be provided by, for example, a spring. After the key is pressed passed a certain point, the attraction between the magnets may dominate and reduce the resistance significantly through the rest of the key stroke. This may result in a positive snap or click as the key reaches the bottom of the key stroke, which may indicate to the user that the actuation is complete.

Compare the tactile response 1100 of FIG. 11A with the tactile response 1150 of an example traditional keyboard key. As shown in FIG. 11B, the resistance also increases to a maximum 1151 and then reduces through the remainder of the keystroke. This is similar to the tactile response 1100 of FIG. 11A. Thus, in some cases, a pair of magnets may be used to mimic the force response of a traditional keyboard.

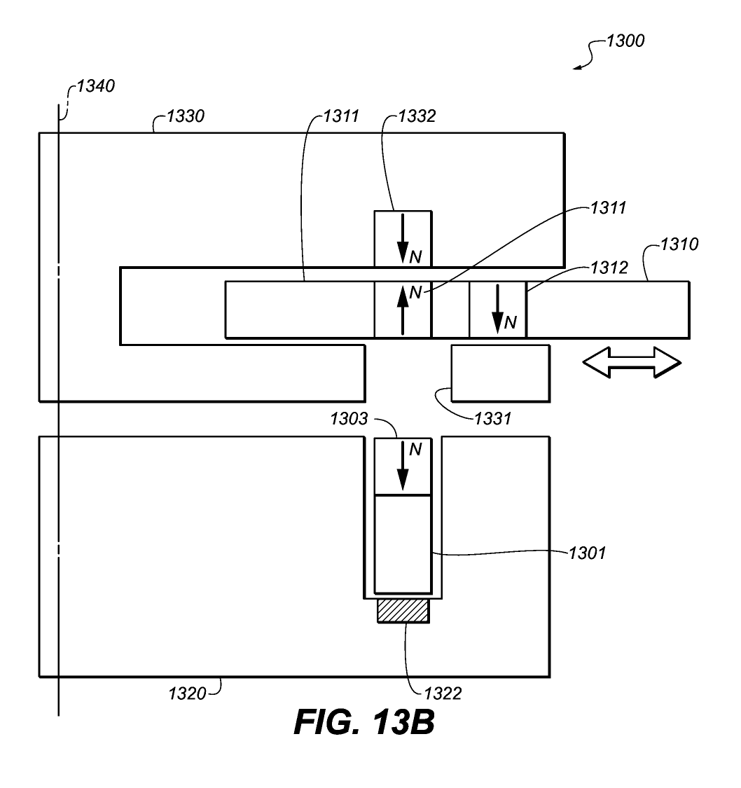

Magnet pairs can be used in combination with other types of mechanisms to perform a latching or locking function. In particular, one or more magnet pairs can be combined with a mechanical lock or pin to lock or latch a mechanism. FIG. 12 depicts a simplified schematic of an example magnetic latch mechanism. In particular, FIG. 12 depicts a latch mechanism 1200 having a first magnet 1211 and second magnet 1212 attached to an actuating member 1210. The actuating member 1210 is configured to move along a first axis as indicated by the arrows in FIG. 12. Also, as shown in FIG. 12, the first and second magnets 1211, 1212 are oriented along the first axis and have opposite polarity orientations.

As shown in FIG. 12, the latch mechanism 1200 also includes a slide 1201 oriented along a second axis that is transverse to the fist axis. In this example, the second axis is perpendicular to the first axis, as indicated by the arrows in FIG. 12. The slide 1201 also includes a third magnet 1202 that is fixed with respect to the slide 1201. As shown in FIG. 12, the third magnet 1202 is located proximate to either one of the first magnet 1211 or the second magnet 1212.

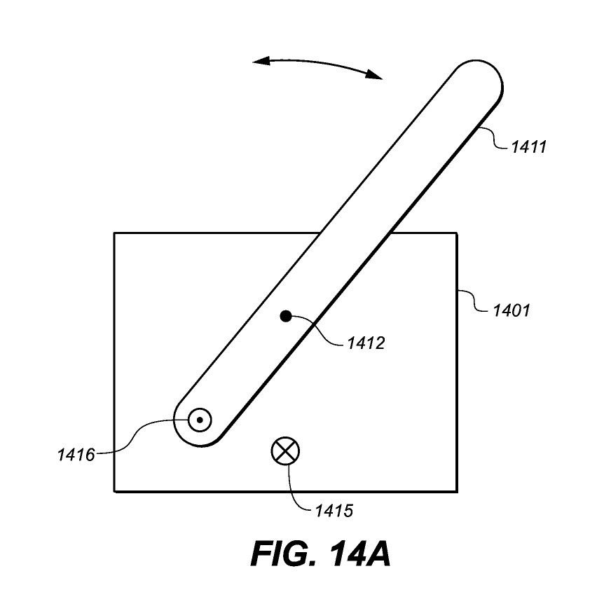

The configuration depicted in FIG. 12 can be used provide a latching function, as described in more detail with respect to FIGS. 13A-B. In particular, the actuating member 1210 can be moved back and forth to use the first or second magnets (1211, 1212) to either attract or repel the third magnet 1202 fixed to the slide 1201. In some cases, the slide 1201 may be used to engage a mechanical lock or latch that inhibits the movement of a mechanism or component. In some cases, first and third magnets are configured to produce an unlocking force when the actuating member is in a first position, and the second and first magnets are configured to produce a locking force when the actuating member is in a second position.

FIGS. 13A-B depict an example magnetic latch mechanism that operates using this principle. In particular, FIGS. 13A-B depict an example latch mechanism 1300 having a first component 1320 and a second component 1330 that are movable with respect to each other. In this example, either the first component 1320 or the second component 1330 or both components are able to rotate about the axis 1340. In alternative embodiments, the components may be able to translate or slide with respect to each other.

In the example depicted in FIGS. 13A-B, the latch mechanism 1300 may be operated by sliding the actuating member 1310 in or out of a recess or hole in the second component 1330. In the present example, the actuating member 1310 slides along a first axis, as indicated by the arrows in FIGS. 13A-B. A first magnet 1311 and second magnet 1312 are fixed with respect to the actuating member 1310 and, thus may be positioned my manipulating the actuating member 1301. Similar to the previous example and as shown in FIGS. 13A-B, the first and second magnets 1311, 1312 are oriented or arranged along the first axis and have opposite polarity orientations.

As shown in FIGS. 13A-B, the latch mechanism 1300 also includes a slide 1301 oriented along a second axis that is transverse to the first axis of the actuating member 1310. In this example, the second axis is perpendicular to the first axis. The slide 1301 also includes a third magnet 1303 that is fixed with respect to the slide 1301. As shown in FIGS. 13A-B, the third magnet 1303 is located proximate to either one of the first magnet 1311 or the second magnet 1312, depending on the location of the actuating member 1310.

The configuration depicted in FIGS. 13A-B can be used provide a latching function. In particular, the actuating member 1310 can be moved back and forth such that the first or second magnets (1311, 1312) either attract or repel the third magnet 1303 fixed to the slide 1301. The forces generated by the interaction between the third magnet 1303 and either the first 1311 or second 1312 magnets cause the slide 1301 to engage or disengage with a mating locking feature 1331 in the second component 1330. In the present example, the slide 1301 engages with a hole formed in the second component 1330. In alternative embodiments, the locking feature 1331 may be formed from a separate part that is attached or fixed with respect to the second component 1330, and may include a pocket, recess, pin, or other feature configured to mechanically engage with the slide 1301. Similarly, in the present example, the slide 1301 is depicted as a pin or bar for simplicity. However, the slide may be formed from a part having a variety of geometries or additional features that are configured to engage with the mating locking feature 1331 of the second component 1330.

As shown in FIG. 13A, the actuating member 1310 may be slid or pushed into the hole or recess of the second component 1330 to substantially align the second magnet 1312 with respect to the third magnet 1303. Because the second magnet 1312 and the third magnet 1303 have the same polarity orientation, the two magnets are attracted to each other. This causes the slide 1301 to move toward the second magnet 1312 and engage the locking feature 1331 in the second component 1330. The engagement of the slide 1301 with the locking feature 1331 prevents the movement of the first component 1320 and second component 1330 with respect to each other. Therefore, the magnet configuration depicted in FIG. 13A can be used to engage a mechanical latch or connection between multiple components.

The actuating member 1310 can also be used to unlock or unlatch the first component 1320 from the second component 1330. As shown in FIG. 13B, the actuating member 1310 may be slid or pulled out of the hole or recess of the second component 1330 to substantially align the first magnet 1311 with respect to the third magnet 1303. Because the first magnet 1311 and the third magnet 1303 have the opposite polarity orientation, the two magnets are repelled from each other. This causes the slide 1301 to move away from the first magnet 1311 and disengage the locking feature 1331 from the second component 1330. The disengagement of the slide 1301 with respect to the locking feature 1331 may restore free movement of the first component 1320 and second component 1330 with respect to each other. Therefore, the magnet configuration depicted in FIG. 13B can be used to disengage a mechanical latch or connection between multiple components.

As shown in FIGS. 13A-B, the latch mechanism 1300 also includes additional magnets that may be used to bias or establish a default location for the components of the mechanism. In particular, the latch mechanism 1300 includes an actuating member retaining magnet 1332, which has a polarity orientation that is substantially aligned with the polarity orientation of the second magnet 1312. Thus, the second magnet 1312 is attracted to the retaining magnet 1332, which helps to maintain the actuating member 1310 in the locked position, as shown in FIG. 13A. While the current example is provided with respect to a normally locked mechanism, an alternative embodiment may flip the polarity orientation of the retaining magnet 1332 to provide a normally unlocked mechanism. Additionally, the polarity of one or more of the other magnets may be flipped to provide a variety of other configurations.

As shown in FIGS. 13A-B, the latch mechanism 1300 may also include a slide retaining magnet 1322, which may be magnetically attracted to the slide 1301. For example, the slide 1301 may be formed from a ferromagnetic material or may include an additional magnet that is configured to be attracted to the retaining magnet 1322. The attraction between the retaining magnet 1322 and the slide 1301 helps to maintain the slide 1301 in the unlocked position, as shown in FIG. 13B and may help prevent inadvertent latching of the latch mechanism 1300.

In the example depicted in FIGS. 13A-B, the actuating member and slide are depicted as extruded or linear members that slide along an axis. However, in alternative embodiments, the actuating member or the slide or both may be configured to rotate about an axis to perform the locking or latching functions described above.

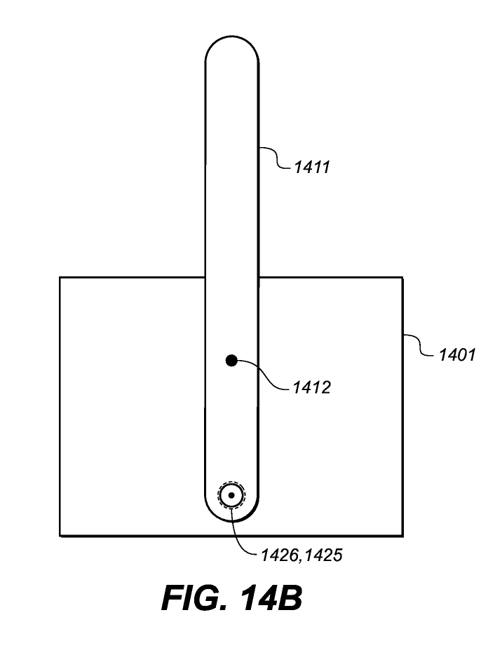

FIGS. 14A-B depict examples of mechanisms having a rotating member. FIG. 14A depicts a mechanism having a rotating member and a magnetic latch. In particular, FIG. 14A depicts a member 1411 that is configured to pivot relative to base 1401 about pivot point 1412. The mechanism may also include one or more hard stops to limit the rotation of the member 1411 in one or more directions. As depicted in FIG. 14A, the member 1411 may be in a right position (as shown) and a left position (approximately opposite to the right position). The member 1411 may also swing through an intermediate position located between the left and right positions. The member 1411 may be actuated left and right by a user or other external actuating force.

In the configuration depicted in FIG. 14A, a pair of magnets 1415, 1416 having opposite polarity may be used to latch the mechanism in one of two positions. As shown in FIG. 14A, a first magnet 1416 is fixed with respect to the member 1411 and located at a position that is offset from the pivot point 1412. In the current example, the first magnet 1416 is located proximate to an end of the member 1411 that is opposite to the other end of the member 1411 used to actuate the mechanism. A second magnet 1415 is fixed with respect to the base 1401 and located in a position that substantially aligns the first 1416 and second 1415 magnets when the member 1411 is in an intermediate position. Generally, the mechanism and location of the magnets are configured so that the first magnet 1416 and the second magnet 1415 are closest when the member 1411 is in the intermediate position.

As indicated in FIG. 14A, the first magnet 1416 has a first polarity and the second magnet 1415 has a second polarity that is opposite to the first polarity. Accordingly, the pair of magnets will tend to repel each other and produce a force that pushes the member 1411 either toward the left position or the right position. The mechanism depicted in FIG. 14A is in an unstable balanced state when the member 1411 is in an intermediate position, when the first 1416 and second 1415 magnets are closest to each other.

Due to the repulsive force between the pair of magnets 1415, 1416, the member 1411 may be latched or held at either the left or right position. In some cases, the pair of magnets 1415, 1416 also produce a tactile toggle and snap as the member 1411 is actuated from one position to the other. In some cases, the tactile feedback produced by the pair of magnets 1415, 1416 is similar to a traditional mechanical toggle switch. Additionally, in some cases, the mechanism of FIG. 14A may be incorporated as part of another mechanism and used as a magnetic lock or magnetic latch to inhibit movement of the mechanism.

FIG. 14B depicts a mechanism having a rotating member and a magnetic catch. Similar to the previous example, FIG. 14B depicts a member 1411 that is configured to pivot relative to base 1401 about pivot point 1412. The mechanism may also include one or more hard stops to limit the rotation of the member 1411 in one or more directions. Also, similar to the previous example, the member 1411 may be actuated left and right by a user or other external actuating force.

As depicted in FIG. 14B, the member 1411 is in an inherently stable position where the two magnets 1425, 1426 are closest to each other. Thus, the mechanism depicted in FIG. 14B may function as a magnetic catch. As shown in FIG. 14B, a first magnet 1426 is fixed with respect to the member 1421 and located at a position that is offset from the pivot point 1412. In the current example, the first magnet 1426 is located proximate to an end of the member 1411 that is opposite to the other end of the member 1411 used to actuate the mechanism. A second magnet 1425 is fixed with respect to the base 1401 and located in a position that substantially aligns the first 1426 and second 1425 magnets when the member 1411 is in an intermediate or upright position, in this particular example. Generally, the mechanism and location of the magnets are configured so that the first magnet 1426 and the second magnet 1425 are closest when the member 1411 is in the intermediate position.

In this example, the first magnet 1426 has a first polarity and the second magnet 1425 has a second polarity that is substantially aligned to or the same as the first polarity. Accordingly, the pair of magnets will tend to attract each other and produce a force that tends to maintain the member 1411 in the intermediate position depicted in FIG. 14B. The mechanism depicted in FIG. 14B is in a stable or balanced state when the member 1411 is in an intermediate position, when the first 1426 and second 1425 magnets are closest to each other.

Because the magnetic catch tends to return the member 1411 in the intermediate position, the mechanism may be used in a variety of switching or actuating mechanisms. For example, a variation of the magnetic catch depicted in FIG. 14B may be used to provide a two-way switch that can be actuated by swinging the member 1411 either left or right. However, when not being actuated, the member 1411 may remain in a center or intermediate unswitched state. Other variations may also be used to provide, for example, a self-centering mechanism that is inherently stable when the pair of magnets 1415, 1416 are closest to each other.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

1. A button mechanism having a magnetic latch, the mechanism comprising:
a base;
a button sliding element slidably engaged with respect to the base, and configured to move between an unactuated and an actuated position;
a first magnet having a first polarity orientation and fixed with respect to the base
a second magnet having a second polarity orientation that is opposite to the first polarity orientation, wherein:
the second magnet is fixed with respect to the button element, and
the second magnet is configured to pass the first magnet when the button element is at an intermediate position as the button is being actuated.

2. The button mechanism of claim 1, wherein the first and second magnets are configured to generate a resistance force that resists an actuation motion when moving the button element from the unactuated position to the intermediate position.

3. The button mechanism of claim 2, wherein the resistance force is at a maximum at a button location immediately before the intermediate position as the button element is being actuated.

4. The button mechanism of claim 1, wherein the first and second magnets are configured to generate a latching force that resists a movement of the button element from the actuated to the unactuated position.

5. The button mechanism of claim 4, wherein the latching force is at a maximum at a button location immediately before the intermediate position as the button element is moved from the actuated to the unactuated position.

6. The button mechanism of claim 1, wherein the button element is a push button and the base is coupled to a housing of a portable electronic device.

7. A button mechanism having a magnetic latch, the mechanism comprising:
a housing;
a button slidably engaged with respect to the housing, and configured to move between an up and down position;
a first magnet having a first polarity orientation and fixed with respect to the housing
a second magnet having a second polarity orientation that is opposite to the first polarity orientation, wherein:
the second magnet is fixed with respect to the button, and
the second magnet is configured to be nearest to the first magnet when the button is at an intermediate position that is between the up and down position.

8. The button mechanism of claim 7, wherein the button is a key of a keyboard device.

9. The button mechanism of claim 7, further comprising:
a spring configured to provide a return force to restore the button to the up position.

10. The button mechanism of claim 7, wherein the second magnet is an electrically actuated electromagnet.

11. The button mechanism of claim 7, wherein the first and second magnets are configured to generate a resistance force that resists an actuation motion when moving the button from the up position to the down position.

12. The button mechanism of claim 11, wherein the resistance force is at a maximum at a button location immediately before the intermediate position as the button is being actuated.

13.-20. (canceled)

21. A button mechanism having a magnetic latch, the mechanism comprising:
a base coupled to a first magnet having a first polarity orientation;
a button movably engaged with respect to the base and coupled to a second magnet having a second polarity orientation that is opposite to the first polarity orientation; wherein: the second magnet is configured to pass the first magnet as the button is being actuated.

22. The button mechanism of claim 21, wherein the second magnet is closest to the first magnet at an intermediate button position that is between an unactuated and an actuated button position.

23. The button mechanism of claim 22, wherein the first and second magnets are configured to provide a positive tactile force as the button is being actuated toward the intermediate position.

24. The button mechanism of claim 21, wherein the first and second magnets are configured to maintain a the button mechanism in an actuated position after being actuated.

25. A portable electronic device comprising:
a housing defining an opening and coupled to a first magnet having a first polarity orientation;
a button positioned within the opening and coupled to second magnet having a second polarity orientation opposite to the first polarity orientation;
a spring coupled to the button and configured to provide a return force on the button, wherein:
the first and second magnets are configured to provide an upward force on the button for a first portion of an actuation of the button; and
the first and second magnets are configured to provide a downward force on the button for a second portion of an actuation of the button.

26. The portable electronic device of claim 25, wherein the spring is configured to provide a return force that is greater than the downward force provided by the first and second magnets while the button is in a depressed position.

27. The portable electronic device of claim 25, wherein the first magnet is an electromagnet that is configured to be selectively actuated.

28. The portable electronic device of claim 27, wherein the electromagnet is momentarily disengaged in response to the button being depressed.
